(19) United States
(12) Patent Application Publication
(10) Pub. No.: US 2019/0093399 A1
(43) Pub. Date: Mar. 28, 2019

(54) ACTUATOR FOR FUEL LID

(71) Applicant: Johnan Manufacturing Inc., Nagano (JP)

(72) Inventor: Yuta SAKURAI, Nagano (JP)

(73) Assignee: Johnan Manufacturing Inc., Nagano (JP)

(21) Appl. No.: 16/081,450

(22) PCT Filed: Feb. 17, 2017
(86) PCT No.: PCT/JP2017/005948

§ 371 Date: Aug. 31, 2018

(30) Foreign Application Priority Data
Mar. 3, 2016 (JP) 2016-041362

(51) Int. Cl. E05B 83/34; E05B 81/16; E05B 85/02

(52) U.S. Cl. CPC E05B 83/34; E05B 81/36; E05B 85/02; E05B 81/16

(57) ABSTRACT

A fuel lid actuator includes a motor, a gear member that rotates within a predetermined angular range associated with the operation of the motor, a moving member that includes a shaft-shaped rod part and is disposed so as to be able to advance and retreat in an axial direction in associated with the rotation of the gear member, and a housing member which includes first and second housing members that house the motor, the gear member and the moving member and in which a cylindrical rod support part for supporting the rod part is installed. The rod support part is in formed into a tubular shape and includes a semi-cylindrical first rod support part installed in the first housing member and a semi-cylindrical second rod support part installed in the second housing member.

### TECHNICAL FIELD

The present invention relates to a fuel lid actuator.

### BACKGROUND ART

A fuel lid actuator to lock and unlock a lid covering and uncovering an opening of a fuel filler portion of a vehicle is known (see, e.g., JP 2015/218446 A).

The fuel lid actuator described in JP 2015/218446 A is provided with a motor, a gear member which rotates within a predetermined angular range by actuation of the motor, a moving member (sliding member) having a shaft-shaped rod which advances and retreats with rotation of the gear member between a protruded position protruding from a case and a retracted position retracted into the case, an elastic member elastically pressing the moving member toward the protruded position, and a housing member which is composed of a first housing member housing the motor, the gear member and the moving member and a second housing member attached to cover an opening of the first housing member.

A cylindrical guide portion for guiding axial movement of the rod is installed in the first housing member, and a guiding through-hole for inserting the rod is installed in the guide portion. The housing member is in communication with the exterior through the guiding through-hole, and a seal member is arranged between the guiding through-hole and the rod.

### CITATION LIST

### Patent Literature

JP 2015/218446 A

### SUMMARY OF INVENTION

### Technical Problem

When attaching the moving member during assembly of the fuel lid actuator described in JP 2015/218446 A, however, it is necessary to insert the rod of the moving member into the guiding through-hole of the guide portion in a relatively narrow space of the first housing member before attaching the second housing member, and this hinders improvement in assembly workability.

It is an object of the invention to provide a fuel lid actuator of which assembly workability is improved.

### Solution to Problem

An fuel lid actuator in an embodiment of the invention comprises a motor, a gear member that rotates within a predetermined angular range associated with the operation of the motor, a moving member that comprises a shaft-shaped rod part and is disposed so as to be able to advance and retreat in an axial direction in associated with the rotation of the gear member, and a housing member which comprises first and second housing members that house the motor, the gear member and the moving member and in which a cylindrical rod support part for supporting the rod part is installed, wherein the rod support part is formed into a tubular shape and comprises a semi-cylindrical first rod support part installed in the first housing member and a semi-cylindrical second rod support part installed in the second housing member.

### Advantageous Effects of Invention

According to an embodiment of the invention, it is possible to provide a fuel lid actuator of which assembly workability is improved.

### BRIEF DESCRIPTION OF DRAWINGS

FIG. 1 is a perspective view showing a fuel filler opening and the periphery of a vehicle body on which a fuel lid actuator in the present embodiment is installed.

FIG. 2 is a cross sectional view showing a structure of a fuel lid and the periphery in a state of being locked by the fuel lid actuator;

FIG. 3A is a plan view showing the fuel lid actuator in a state that a first housing member and a second housing member are assembled.

FIG. 3B is a plan view showing the fuel lid actuator in a state that the second housing member is removed from the first housing member.

FIG. 4 is an exploded perspective view showing the fuel lid actuator shown in FIG. 3A.

FIG. 5A is a top view showing the fuel lid actuator.

FIG. 5B is a cross sectional view taken along a line A-A in FIG. 5A.

### DESCRIPTION OF EMBODIMENTS

### Embodiment

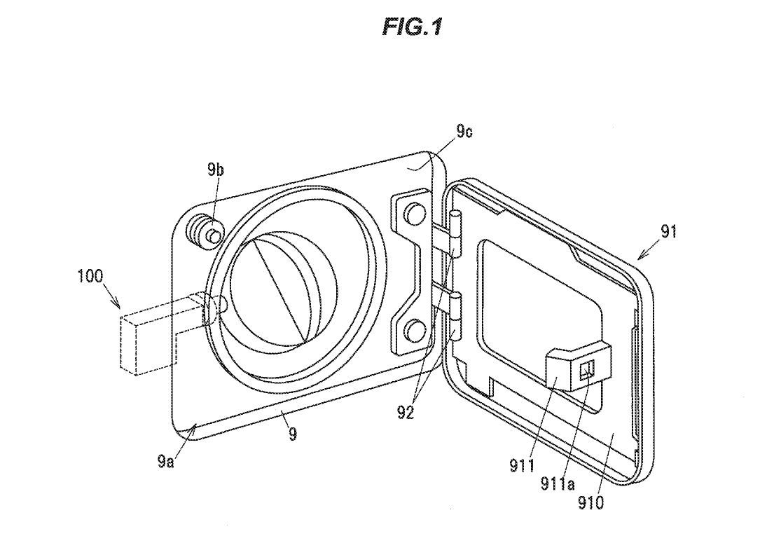

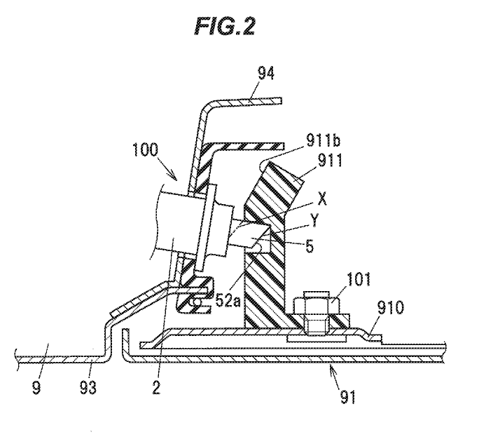

The configuration and operation of a fuel lid actuator in an embodiment of the invention will be described in reference to FIGS. 1 to 5B. The fuel lid actuator is used to lock and unlock a fuel lid 91 which covers and uncovers a fuel filler opening 9a of a vehicle body 9. A fuel lid actuator 100 is schematically shown in FIGS. 1 and 2.

FIG. 1 is a perspective view showing the fuel filler opening 9a and the fuel lid 91 of the vehicle body on which the fuel lid actuator 100 in the present embodiment is installed.

FIG. 2 is a cross sectional view showing a structure of the fuel lid 91 and the periphery in a state of being locked by the fuel lid actuator 100.

As shown in FIG. 1, the fuel lid 91 is openably/closably attached to the vehicle body 9 by hinges 92 and covers or uncovers the fuel filler opening 9a provided on the vehicle body 9. A locking plate 911 to be engaged with the fuel lid actuator 100 is provided on an attachment bearing surface 910 which is located on the inner side of the fuel lid 91. A recessed portion 911a to be engaged with a tip portion of a moving member 5 (described later) of the fuel lid actuator 100 is formed on the locking plate 911. An open spring 9b for applying a force in an opening direction of the fuel lid 91 is provided on a facing surface 9c of the vehicle body 9 which faces the attachment bearing surface 910 of the fuel lid 91.

As shown in FIG. 2, the locking plate 911 is a member formed of, e.g., a resin and is fixed to the attachment bearing surface 910 of the fuel lid 91 by a bolt 101. The fuel lid actuator 100 is fixed, via a vehicle body attachment member 80, to an inner panel 94 of the vehicle body 9 provided inside with respect to an outer panel 93.

When the fuel lid 91 is closed, the tip portion of the moving member 5 of the fuel lid actuator 100 is engaged with the recessed portion 911a of the locking plate 911 of the fuel lid 91 and the fuel lid 91 is thereby locked in the closed state. Then, when opening the fuel lid 91, the fuel lid actuator 100 is activated by, e.g., a driver's operation on a lid opener provided on a driver's seat, and the moving member 5 moves from a protruded position Y protruding from a case 2, to a retracted position X (dash-dot-dot line) retracted into the case 2. Accordingly, the tip portion of the moving member 5 is withdrawn from the recessed portion 911a of the locking plate 911 of the fuel lid 91, and the fuel lid 91 receives a force from the open spring 9b and is half-opened. In this manner, the fuel lid 91 is unlocked and opened.

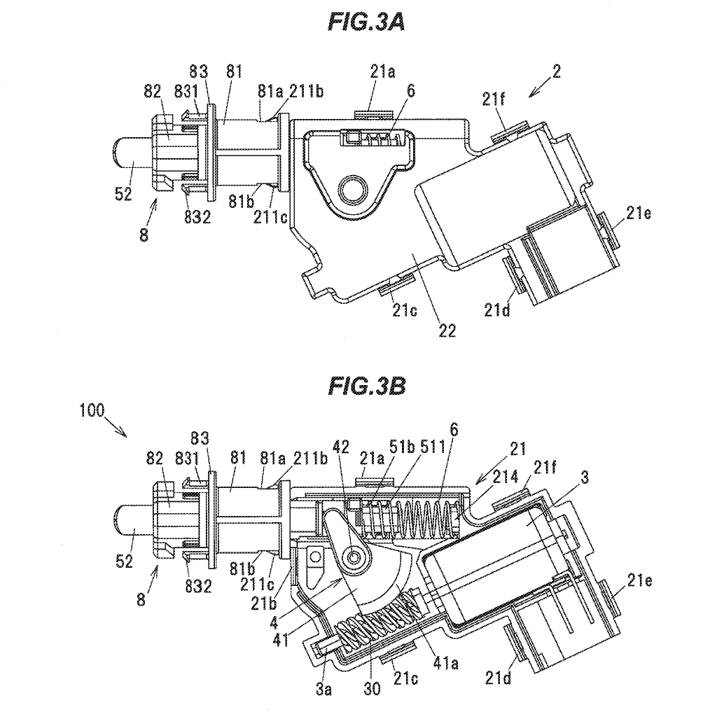

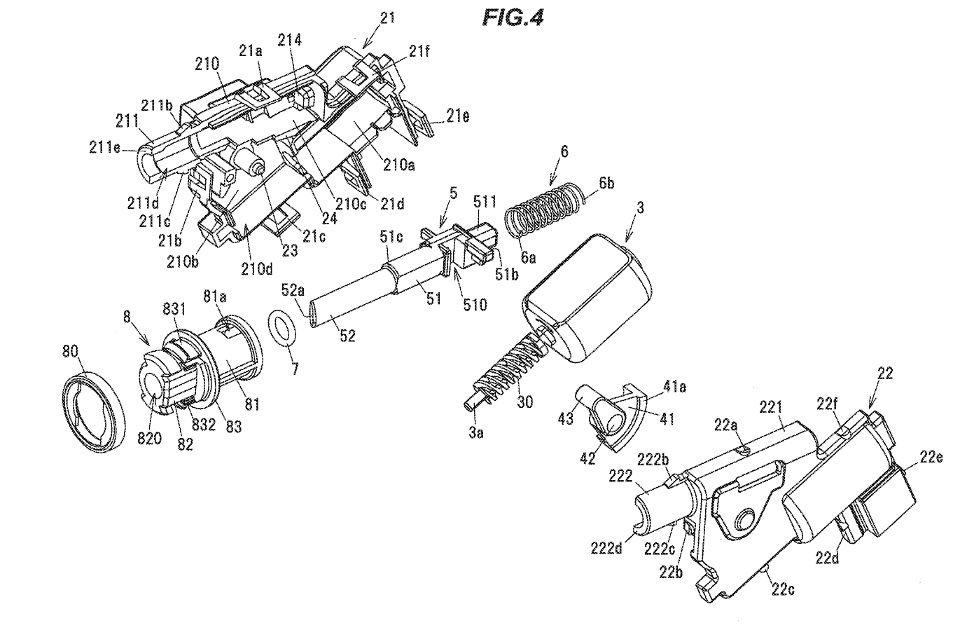

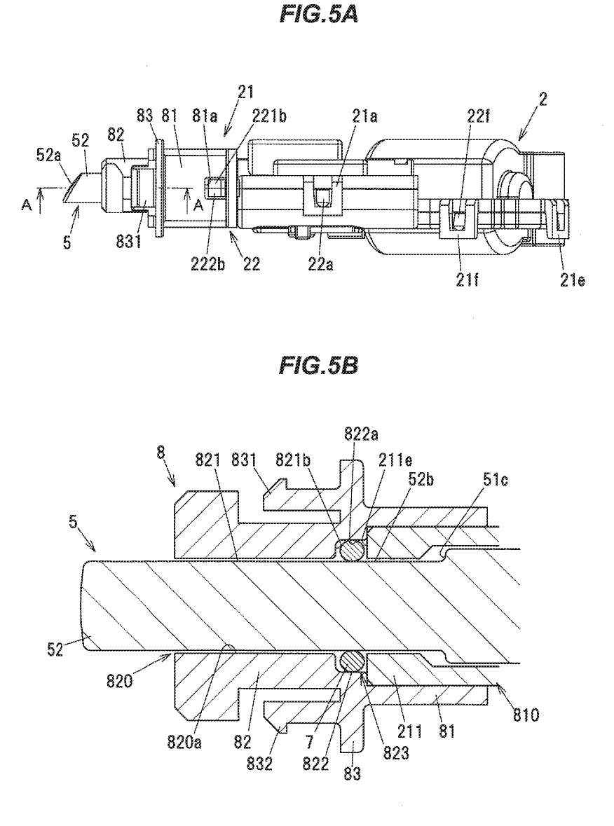

FIG. 3A is a plan view showing an assembled state in which a second housing member 22 is attached to a first housing member 21, and FIG. 3B is a plan view showing a state in which the second housing member 22 is removed from the first housing member 21. FIG. 4 is an exploded perspective view showing the fuel lid actuator 100 in FIG. 3A. FIG. 5A is a top view showing the fuel lid actuator and FIG. 5B is a cross sectional view taken along the line A-A in FIG. 5A.

The fuel lid actuator 100 has a motor 3 having an output shaft 3a coupled to a worm 30, a sector gear 4 as a gear member which rotates within a predetermined angular range by actuation of the motor 3, the moving member 5 having a shaft-shaped rod part 52 and arranged to be able to advance and retreat in an axial direction with rotation of the sector gear 4, the housing member 2 which is composed of the first housing member 21 and the second housing member 22 and houses the motor 3, the sector gear 4 and the moving member 5, a coil spring 6 as an elastic member for applying a force to the moving member 5 in a predetermined direction, a cylindrical member 8 having a cylindrical shape and fixing first and second rod support parts 211 and 222 which are respectively provided on the first and second housing members 21 and 22, and a seal member 7 arranged between the cylindrical member 8 and the moving member 5.

The sector gear 4 integrally has a fan-shaped portion 41 formed in an arc shape, a rotating shaft portion 42 rotatably coupled to a pin 23 of a case main portion 210 of the first housing member 21, and an engaging portion 43 provided on the side opposite to the fan-shaped portion 41 with respect to the rotating shaft portion 42 and engaged with the moving member 5. A gear portion 41a meshing with the worm 30 is formed on the outer periphery of the fan-shaped portion 41.

The moving member 5 is a member formed in a shaft shape as a whole, and integrally has a main body 51 having an engagement hole 510 to be engaged with the engaging portion 43 of the sector gear 4, and the columnar rod part 52 which further extends in an extending direction of the main body 51 from an axial end face 51c of the main body 51 on the opposite side to the coil spring 6.

A protruding portion 511 is provided on the main body 51 so as to protrude from an end face 51b located on the opposite side to the axial end face 51c. The protruding portion 511 is formed as a spring coupling portion which is coupled to an end 6a of the coil spring 6.

An outer peripheral surface 52b of the rod part 52 is a smooth surface without pits and bumps throughout the axial and circumferential directions. In addition, an inclined surface 52a inclined with respect to the axial direction is formed at a tip of the rod part 52. The inclined surface 52a is formed as a sliding surface which slides on an end face 911b of the locking plate 911 during the closing operation of the fuel lid 91 (see FIG. 2). This reduces shock on the locking plate 911 of the fuel lid 91 and on the moving member 5 during the closing operation of the fuel lid 91.

The coil spring 6 is arranged in a compressed state, with the end 6a thereof coupled to the protruding portion 511 of the main body 51 of the moving member 5 and another end 6b coupled to a projecting portion 214 formed on a slidably-housing portion 210c of the first housing member 21 (described later). Thus, the moving member 5 constantly receives a force from the coil spring 5 in the axial direction, from the retracted position toward the protruded position.

The first housing member 21 has the case main portion 210 which has a motor housing portion 210a for housing the motor 3, a gear housing portion 210b for housing the sector gear 4 and the slidably-housing portion 210c slidably housing the main body 51 of the moving member 5, and the first rod support part 211 which has a semi-cylindrical shape and is formed to protrude from the case main portion 210 in the axial direction of the moving member 5.

The first housing member 21 also has first to sixth projections 21a to 21f which are respectively engaged with first to sixth locking claws 22a to 22f provided on the second housing member 22. This configuration allows the first housing member 21 and the second housing member 22 to be fastened to each other. The gear housing portion 210b and the slidably-housing portion 210c of the first housing member 21 are divided by a partition wall 24.

The second housing member 22 has a cover main portion 221 which covers an opening 210d formed over the motor housing portion 210a, the gear housing portion 210b and the slidably-housing portion 210c of the first housing member 21, and the second rod support part 222 which has a semi-cylindrical shape, is formed to protrude from the cover main portion 221 in the axial direction of the moving member 5 and covers an opening 211d of the first rod supporting portion 221. The first rod support part 211 and the second rod support part 222 form a rod support part which axially movably support the rod part 52 of the moving member 5.

In the state that the second housing member 22 is attached to the first housing member 21, the first rod support part 211 and the second rod support part 222 are combined and form a cylindrical shape. This cylinder-shaped section is formed as the rod support part which axially movably support the rod part 52.

The first rod support part 211 has first and second locking claws 211b and 211c which are formed on the outer periphery and are respectively engaged with first and second locking holes 81a and 81b formed on a first cylindrical portion 81 of the cylindrical member 8 (described later). Likewise, the second rod support part 222 has first and second locking claws 222b and 222c which are formed on the outer periphery and are respectively engaged with the first and second locking holes 81a and 81b formed on the first cylindrical portion 81 of the cylindrical member 8. The first locking claw 211b of the first rod support part 211 and the first locking claw 222b of the second rod support part 221 form one locking claw, and the second locking claw 211c of the first rod support part 211 and the second locking claw 222c of the second rod support part 222 form one locking claw.

The cylindrical member 8 is a member having a substantially cylindrical shape, and has the first cylindrical portion 81 fitted around the first rod support part 211 of the first housing member 21 and the second rod support part 222 of the second housing member 22, a second cylindrical portion 82 having an insertion hole 820 having an inner peripheral surface 820a facing the outer peripheral surface 52b of the rod part 52 of the moving member 5, and a flange portion 83 arranged between the first cylindrical portion 81 and the second cylindrical portion 82.

The first cylindrical portion 81 has a housing hole 810 for housing the first and second rod support parts 211 and 221 and opens on the first and second rod support parts 211 and 221 side of the moving member 5. The first and second locking holes 81a and 81b of the first cylindrical portion 81 are respectively engaged with the first locking claws 211b, 222b and the second locking claws 211c, 222c of the first housing member 21 and the second housing member 22. This configuration prevents the cylindrical member 8 from coming off from the first and second housing members 21 and 22.

The insertion hole 820 of the second cylindrical portion 82 has a small diameter portion 821 and a large diameter portion 822 which have different inner diameters from each other.

In the present embodiment, the large diameter portion 822 is the closest to the first cylindrical portion 81 in the axial direction of the insertion hole 820. The insertion hole 820 of the second cylindrical portion 82 and the housing hole 810 of the first cylindrical portion 81 are connected in the axial direction.

The inner peripheral surface 820a of the second cylindrical portion 82 in the insertion hole 820 is in sliding contact with the outer peripheral surface 52b of the rod part 52 as the moving member 5 moves in the axial direction. That is, the insertion hole 820 is formed as a guide hole and the inner peripheral surface 820a guides the axial movement of the rod part 52 of the moving member 5.

The flange portion 83 is located on a radially outer side of the large diameter portion 822 and has an outer diameter larger than the first cylindrical portion 81 and the second cylindrical portion 82. In addition, the flange portion 83 has first and second claws 831 and 832 which are formed to extend in an axial direction from an axial end face on the second cylindrical portion 82 side. The first and second claws 831 and 832 lock the ring-shaped vehicle body attachment member 80.

A housing portion 823 for housing the seal member 7 is provided on the second cylindrical portion 82 of the cylindrical member 8. In the present embodiment, the housing portion 823 is formed in the insertion hole 820 of the second cylindrical portion 82 of the cylindrical member 8. The seal member 7 is an annular member and is, e.g., an O-ring.

The housing portion 823 is a space surrounded by end faces 211e and 222d of the first and second rod support parts 211 and 222, an inner peripheral surface 822a of the large diameter portion 822 of the second cylindrical portion 82, a level difference surface 821b between the large diameter portion 822 and the small diameter portion 821, and the outer peripheral surface 52b of the rod part 52 of the moving member 5. The level difference surface 821b faces the end faces 211e and 222d of the first and second rod support parts 211 and 222 in the axial direction.

The seal member 7, in an elastically compressed state, is tightly in contact with the inner peripheral surface 822a of the large diameter portion 822 and the outer peripheral surface 52b of the rod part 52 of the moving member 5. That is, a gap between the second cylindrical portion 82 of the cylindrical member 8 and the rod part 52 of the moving member 5 is sealed with the seal member 7. This prevents ingress of water through the insertion hole 820 of the second cylindrical portion 82 of the cylindrical member 8 into the housing member 2.

During the unlocking operation of the fuel lid actuator 100 configured as described above, the sector gear 4 rotates in a clockwise direction of FIG. 3 by actuation of the motor 3 in the state that the fuel lid 91 is closed, and the moving member 5 moves from the protruded position Y toward the retracted position X against a force applied by the coil spring 6 (see FIG. 2). Thus, the tip of the rod part 52 of the moving member 5 is withdrawn from the recessed portion 911a of the locking plate 911 of the fuel lid 91, and the locked state is thereby released.

On the other hand, during the locking operation of the fuel lid actuator 100, the end face 911b of the locking plate 911 of the fuel lid 91 comes into contact with the inclined surface 52a of the rod part 52 of the moving member 5 by closing movement of the fuel lid 91, and the moving member 5 is thereby pushed from the protruded position into the retracted position. Then, the moving member 5, once moved to the retracted position, moves to the protruded position again due to a force applied by the coil spring 6, and the tip of the rod part 52 is engaged with the recessed portion 911a of the locking plate 911 of the fuel lid 91. The fuel lid 91 is thereby locked.

When assembling the fuel lid actuator 100, the motor 3, the sector gear 4 and the moving member 5 with the coil spring 6 attached are respectively housed in the motor housing portion 210a, the gear housing portion 210b and the slidably-housing portion 210c of the first housing member 21 from the openings 211d/210d side. At this time, the moving member 5 is moved in a direction along the rotating axis of the sector gear 4, and the rod part 52 of the moving member 5 is housed in the slidably-housing portion 210c from the opening 211d side of the first rod support part 211.

Next, the second housing member 22 is attached so that the openings 211d and 210d of the first housing member 21 are covered with the second housing member 22. At this time, the second rod support part 222 of the second housing member 22 is moved toward the first rod support part 211 in the direction along the rotating axis of the sector gear 4, and the second rod support part 222 is attached to the first rod support part 211 so as to cover the opening 211d of the first rod support part 211.

Then, the first housing member 21 and the second housing member 22 are fastened to each other by engaging the first to sixth locking claws 22a to 22f of the second housing member 22 with the first to sixth protruding portions 21a to 21f of the first housing member 21. Then, after the seal member 7 is fitted around the rod part 52 of the moving member 5 and is brought into contact with the end faces 211e and 222d of the first and second rod support parts 211 and 222, the cylindrical member 8 is fitted and fixed to the first and second rod support parts 211 and 222. Assembly of the fuel lid actuator100 is thereby completed.

Functions and Effects of the Embodiment

The following functions and effects are obtained in the present embodiment.

(1) The fuel lid actuator 100 is provided with the housing member 2 composed of the first and second housing members 21 and 22 in which the semi-cylindrical first and second rod support parts 211 and 222 for supporting the rod part 52 of the moving member 5 are formed. That is, the present embodiment uses the two semi-cylindrical first and second rod support parts 211 and 222 which, once the first and second housing members 21 and 22 are assembled, function in a similar way to the cylindrical guide portion of the first housing member described in JP 2015/218446 A. Thus, time-consuming task to insert the rod into the cylindrical guide portion of the first housing member (which is installed so as to guide the axial movement of the rod) by moving the rod in the axial direction, which is required to assemble the fuel lid actuator described in JP 2015/218446 A, is not necessary when assembling the fuel lid actuator 2. That is, since the first rod support part 211 has a semi-cylindrical shape with the opening 211d, the motor 3, the sector gear 4 and the moving member 5 can be housed in the first housing member 21 by moving in the same direction (the direction along the rotating axis of the sector gear 4), hence, workability during assembly can be improved.

(2) The fuel lid actuator 100 is provided with the cylindrical member 8 and the seal member 7 for sealing a gap between the second cylindrical portion 82 of the cylindrical member 8 and the rod part 52 of the moving member 5, and the housing portion 823 for housing the seal member 7 is provided on the second cylindrical portion 82 of the cylindrical member 8. Since this eliminates the necessity of forming a groove for arranging the seal member on the rod part side which is provided in, e.g., the fuel lid actuator described in JP 2015/218446 A, the rod part 52 can have the entirely smooth outer peripheral surface. Thus, it is possible to improve strength of the moving member 5.

(3) The housing portion 823 is a space surrounded by the end faces 211e and 222d of the first and second rod support parts 211 and 222, the inner peripheral surface 822a of the large diameter portion 822 of the second cylindrical portion 82, the level difference surface 821b between the large diameter portion 822 and the small diameter portion 821, and the outer peripheral surface 52b of the rod part 52. This configuration allows the seal member 7 to be held and the gap between the rod part 52 of the moving member 5 and the cylindrical member 8 to be sealed. In other words, it is possible to ensure waterproofing.

(4) Since the first rod support part 211 of the first housing member 21 and the second rod support part 222 of the second housing member 22 are fixed by the cylindrical member 8, strength of the housing member 2 is improved.

Although the invention has been described based on the embodiment, the invention according to claims is not to be limited to the embodiment described above.

Further, please note that all combinations of the features described in the embodiment are not necessary to solve the problem of the invention. In addition, the invention can be appropriately modified and implemented without departing from the gist thereof.

### REFERENCE SIGNS LIST

3 MOTOR

4 SECTOR GEAR

5 MOVING MEMBER

7 SEAL MEMBER

8 CYLINDRICAL MEMBER

21 FIRST HOUSING MEMBER

22 SECOND HOUSING MEMBER

52 ROD PART

211 FIRST ROD SUPPORT PART

222 SECOND ROD SUPPORT PART

820 INSERTION HOLE

820a INNER PERIPHERAL SURFACE

821 SMALL DIAMETER PORTION

821b LEVEL DIFFERENCE SURFACE

822 LARGE DIAMETER PORTION

822a INNER PERIPHERAL SURFACE

823 HOUSING PORTION

1. A fuel lid actuator, comprising:
a motor;
a gear member that rotates within a predetermined angular range associated with the operation of the motor;
a moving member that comprises a shaft-shaped rod part and is disposed so as to be able to advance and retreat in an axial direction in associated with the rotation of the gear member; and
a housing member which comprises first and second housing members that house the motor, the gear member and the moving member and in which a cylindrical rod support part for supporting the rod part is installed,
wherein the rod support part is in formed into a tubular shape and comprises a semi-cylindrical first rod support part installed in the first housing member and a semi-cylindrical second rod support part installed in the second housing member.

2. The fuel lid actuator according to claim 1, further comprising:
a cylindrical member that comprises a first cylindrical portion fitted around the first and second rod support parts and a second cylindrical portion comprising an insertion hole comprising an inner peripheral surface facing an outer peripheral surface of the rod part; and
a seal member for sealing a gap between the second cylindrical portion of the cylindrical member and the rod part,
wherein a housing portion for housing the seal member is provided on the second cylindrical portion of the cylindrical member.

3. The fuel lid actuator according to claim 2, wherein the insertion hole of the second cylindrical portion comprises a small diameter portion and a large diameter portion that have different inner diameters from each other, and the housing portion comprises a space surrounded by end faces of the first and second rod support parts, an inner peripheral surface of the large diameter portion of the second cylindrical portion, a level difference surface between the large diameter portion and the small diameter portion, and the outer peripheral surface of the rod part.
